(19) United States
(12) Patent Application Publication
(10) Pub. No.: US 2010/0267980 A1
(43) Pub. Date: Oct. 21, 2010

(54) CURING ACCELERATOR FOR DEEP-ULTRAVIOLET-TRANSMITTING EPOXY RESIN, DEEP-ULTRAVIOLET-TRANSMITTING EPOXY RESIN COMPOSITION, AND DEEP-ULTRAVIOLET-TRANSMITTING EPOXY RESIN CURED PRODUCT

(75) Inventors: Katsuhiko TSUNASHIMA, Tokyo (JP); Masashi SUGIYA, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIPPON CHEMICAL INDUSTRIAL CO., LTD., Tokyo (JP)

(21) Appl. No.: 12/782,158

(22) Filed: May 18, 2010

Related U.S. Application Data
(62) Division of application No. 12/297,073, filed on Oct. 14, 2008.

(30) Foreign Application Priority Data
Apr. 14, 2006 (JP) 2006-112050

(51) Int. Cl. C07F 9/09

(52) U.S. Cl. 558/87

(57) ABSTRACT

An object of the present invention is to provide a deep-ultraviolet-transmitting epoxy resin cured product having high heat resistance and high resistance to deep-ultraviolet light, and to provide a curing accelerator and an epoxy resin composition which are used for producing the epoxy resin cured product. The curing accelerator for deep-ultraviolet-transmitting epoxy resins comprises a tetraalkylphosphonium dialkyl phosphate represented by the following general formula (1):

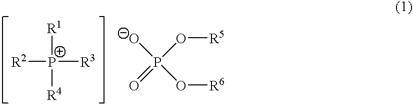

wherein R¹, R², R³, R⁴, R⁵, and R⁶ each represent an alkyl group or an alkyl group having a hydroxyl group, which has 1 to 8 carbon atoms and is linear, branched, or alicyclic; and R¹, R², R³, R⁴, R⁵, and R⁶ may be the same or different. Also disclosed are an epoxy resin composition comprising the curing accelerator and an epoxy resin cured product obtained by curing the resin composition.

This application is a division of U.S. application Ser. No. 12/297,073 filed on Oct. 14, 2008, which is a 371 National Stage of PCT/JP2007/058130 which is based upon and claims the benefit of priority from the prior Japanese Patent Application No. 2006-112050, filed on Apr. 14, 2006, the entire contents of which are incorporated herein by reference.

### TECHNICAL FIELD

The present invention relates to a deep-ultraviolet-transmitting epoxy resin cured product excellent in light-transmitting properties, heat resistance, and resistance to deep-ultraviolet light, and to a curing accelerator for deep-ultraviolet-transmitting epoxy resins and a deep-ultraviolet-transmitting epoxy resin composition which are used for producing the deep-ultraviolet-transmitting epoxy resin cured product.

### BACKGROUND ART

Conventionally, a cured product of an epoxy resin composition has been used as a sealing material for sealing optical semiconductor devices such as LED. The epoxy resin composition usually comprises an epoxy resin, a curing agent, and a curing accelerator.

In recent years, there has been developed an LED or the like having an increased luminance and a shorter-wavelength structure, and optical semiconductor devices for the ultraviolet region, particularly for the deep-ultraviolet region have been actively developed.

However, since the light in the deep-ultraviolet region has very high energy, a sealing material is liable to undergo a decrease in light-transmitting properties and a discoloration upon irradiation with deep-ultraviolet light, and a performance reduction such as decrease in the luminance of optical semiconductor devices such as an LED and a color change are liable to occur. Therefore, a high resistance to deep-ultraviolet light is required for a sealing material for optical semiconductor devices for the deep-ultraviolet region. Note that, in the present invention, the resistance to deep-ultraviolet light refers to a difficulty in the decrease in light-transmitting properties of a sealing material and a difficulty in discoloration thereof when it is irradiated with deep-ultraviolet light; a high resistance to deep-ultraviolet light refers to only a small decrease in light-transmitting properties of a sealing material and only a small degree of discoloration thereof when it is irradiated with deep-ultraviolet light; and on the other hand, a low resistance to deep-ultraviolet light refers to a large decrease in light transmittance of a sealing material or a large degree of discoloration thereof.

The decrease in light-transmitting properties of a sealing material and discoloration thereof are caused by the absorbance of a high-energy deep-ultraviolet light by a sealing material. If an epoxy resin or a curing agent in an epoxy resin composition has a photosensitive site such as an unsaturated bond, an aromatic ring, halogen except fluorine, sulfur, selenium, or tellurium, the resistance to deep-ultraviolet light of a sealing material will be low because the photosensitive site is liable to absorb deep-ultraviolet light. Thus, there have been proposed a deep-ultraviolet-transmitting epoxy resin composition which has difficulty in absorbing deep-ultraviolet light, that is, has high deep-ultraviolet-transmitting properties and a cured product thereof.

For example, Japanese Patent Laid-Open No. 2003-12896 (Patent Document 1) discloses an epoxy resin composition comprising a hydrogenated bisphenol A glycidyl ether, an alicyclic epoxy, a methylhexahydrophthalic anhydride, and tetrabutylphosphonium diethylphosphorodithioate, and a cured product thereof. In Patent Document 1, there are used a hydrogenated bisphenol A glycidyl ether and an alicyclic epoxy which have deep-ultraviolet-transmitting properties as epoxy resins, methylhexahydrophthalic anhydride having deep-ultraviolet-transmitting properties as a curing agent, and tetrabutylphosphonium diethylphosphorodithioate as an operative accelerator.

A sealing material generates a large amount of heat by absorbing only a small amount of deep-ultraviolet light because the deep-ultraviolet light has high energy. Further, with the increase in luminance of light-emitting devices such as an LED, generation of heat from the LED is also increased. Therefore, in addition to high resistance to deep-ultraviolet light, high heat-resistance is required for the deep-ultraviolet-transmitting epoxy resin cured product.
Patent Document 1: Japanese Patent Laid-Open No. 2003-12.896

### DISCLOSURE OF THE INVENTION

However, even the epoxy resin cured product described in Patent Document 1 was still insufficient in the resistance to deep-ultraviolet light and showed decrease in optical semiconductor device performance due to decrease in light-transmitting properties or discoloration. Thus, there was a problem that sufficient performance as a sealing material was not obtained. Further, the epoxy resin cured product described in Patent Document 1 also had a problem that heat resistance was insufficient.

Therefore, an object of the present invention is to provide a deep-ultraviolet-transmitting epoxy resin cured product having high heat resistance and high resistance to deep-ultraviolet light, and to provide a curing accelerator for deep-ultraviolet-transmitting epoxy resins and a deep-ultraviolet-transmitting epoxy resin composition which are used for producing the deep-ultraviolet-transmitting epoxy resin cured product.

As a result of intensive study by the present inventors under the circumstances as described above, the following has been found, and the present invention has been completed: (1) a specific tetraalkylphosphonium dialkyl phosphate has high light-transmitting properties to the light of a wide wavelength region and is particularly excellent in ultraviolet light transmittance in the deep-ultraviolet region; (2) therefore, a cured product having high resistance to deep-ultraviolet light can be obtained by using a tetraalkylphosphonium dialkyl phosphate represented by the following general formula (1) as a curing accelerator for a deep-ultraviolet-transmitting epoxy resin composition; and (3) in addition, the cured product obtained using the tetraalkylphosphonium dialkyl phosphate represented by the following general formula (1) also has high heat resistance.

Specifically, the present invention (1) provides a curing accelerator for deep-ultraviolet-transmitting epoxy resins, characterized by comprising a tetraalkylphosphonium dialkyl phosphate represented by the following general formula (1):

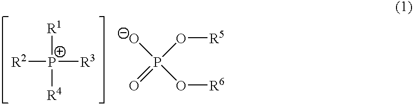

wherein R¹, R², R³, R⁴, R⁵, and R⁶ each represent an alkyl group or an alkyl group having a hydroxyl group, which has 1 to 8 carbon atoms and is linear, branched, or alicyclic; and
R¹, R², R³, R⁴, R⁵, and R⁶ may be the same or different.

The present invention (2) also provides a method for producing a curing accelerator for deep-ultraviolet-transmitting epoxy resins,
characterized by comprising reacting a tertiary phosphine represented by the following general formula (2):

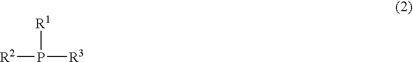

wherein R¹, R², and R³ each represent an alkyl group or an alkyl group having a hydroxyl group, which has 1 to 8 carbon atoms and is linear, branched, or alicyclic; and R¹, R², and R³ may be the same or different,
with a phosphoric ester represented by the following general formula (3):

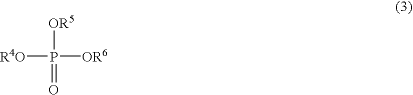

wherein R⁴, R⁵, and R⁶ each represent an alkyl group or an alkyl group having a hydroxyl group, which has 1 to 8 carbon atoms and is linear, branched, or alicyclic; and R⁴, R⁵, and R⁶ may be the same or different.

The present invention (3) also provides a deep-ultraviolet-transmitting epoxy resin composition, characterized by comprising an epoxy resin, a carboxylic anhydride curing agent, and a curing accelerator, wherein the curing accelerator is a curing accelerator for deep-ultraviolet-transmitting epoxy resins according to the present invention (1); and
the content of the curing accelerator is from 0.01 to 10 parts by mass based on 100 parts by mass of the epoxy resin.

The present invention (4) also provides a deep-ultraviolet-transmitting epoxy resin cured product, characterized in that the cured product is obtained by curing the deep-ultraviolet-transmitting epoxy resin composition according to the present invention (3).

### BRIEF DESCRIPTION OF THE DRAWINGS

FIG. 1 is a UV absorption spectrum of methyltri-n-butylphosphonium dimethyl phosphate obtained in Example 1;

FIG. 2 is a UV absorption spectrum of tetra-n-butylphosphonium di-n-butyl phosphate obtained in Example 2;

FIG. 3 is a UV absorption spectrum of tetra-n-butylphosphonium di-n-octyl phosphate obtained in Example 3;

FIG. 4 is a UV absorption spectrum of a commercially available tetra-n-butyl phosphonium o,o-diethylphosphorodithioate in Comparative Example 1;

FIG. 5 is a UV absorption spectrum of a commercially available tetraphenyl phosphonium bromide in Comparative Example 2;

FIG. 6 is a UV absorption spectrum of a commercially available 2-ethyl-4-methylimidazole in Comparative Example 3;

FIG. 7 is a graph showing the change of A values with time in the test for resistance to deep-ultraviolet light;

FIG. 8 is a graph showing the change of yellowing factors with time in the test for resistance to deep-ultraviolet light; and

FIG. 9 is a graph showing the change of yellowing factors with time in the heat resistance test.

### BEST MODE FOR CARRYING OUT THE INVENTION

The curing accelerator for deep-ultraviolet-transmitting epoxy resins of the present invention is a tetraalkylphosphonium dialkyl phosphate represented by the general formula (1). Note that, in the present invention, deep-ultraviolet light means ultraviolet light having a wavelength of 350 nm or less, preferably from 230 to 350 nm.

In the general formula (1), R¹, R², R³, and R⁴ each represent an alkyl group or an alkyl group having a hydroxyl group, have 1 to 8 carbon atoms, and are linear, branched, or alicyclic. Examples of the alkyl groups for R¹, R², R³, and R⁴ include a methyl group, an ethyl group, an n-propyl group, an iso-propyl group, an n-butyl group, a sec-butyl group, a tert-butyl group, an n-pentyl group, an n-hexyl group, a cyclopentyl group, and a cyclohexyl group. Among these, a linear alkyl group having 1 to 4 carbon atoms such as a methyl group or an n-butyl group is preferred in that there is no tendency that the ultraviolet absorption region extends to the long wavelength side, thereby improving resistance to deep-ultraviolet light. In the case where R¹, R², R³, and R⁴ each represent an alkyl group having a hydroxyl group, the number of hydroxyl groups per one alkyl group having a hydroxyl group is preferably one. Examples of the alkyl group having a hydroxyl group for R¹, R², R³, and R⁴ include a 2-hydroxyethyl group and a 3-hydroxypropyl group. Among these, a 3-hydroxypropyl group is preferred in that it has high compatibility with an epoxy resin. Note that, R¹, R², R³, and R⁴ may be the same or different.

In the general formula (1), R⁵ and R⁶ each represent an alkyl group or an alkyl group having a hydroxyl group, have 1 to 8 carbon atoms, and are linear, branched, or alicyclic. Examples of the alkyl groups for R⁵ and R⁶ include a methyl group, an ethyl group, an n-propyl group, an iso-propyl group, an n-butyl group, a sec-butyl group, a tert-butyl group, an n-pentyl group, an n-hexyl group, an n-octyl group, a cyclopentyl group, a cyclohexyl group. Among these, a linear alkyl group having 1 to 8 carbon atoms such as a methyl group, an n-butyl group, or an n-octyl group is preferred in that there is no tendency that the ultraviolet absorption region extends to the long wavelength side, thereby improving resistance to deep-ultraviolet light. In the case where R⁵ and R⁶ each represent an alkyl group having a hydroxyl group, the number of hydroxyl groups per one alkyl group having a hydroxyl group is preferably one. Examples of the alkyl groups having a hydroxyl group for R⁵ and R⁶ include a 2-hydroxyethyl group and a 3-hydroxypropyl group. Among these, a 3-hydroxypropyl group is preferred in that it has high compatibility with an epoxy resin. Note that, R⁵ and R⁶ may be the same or different.

Examples of the tetraalkylphosphonium dialkyl phosphate represented by the general formula (1) include the following compounds:

### (Dimethyl Phosphate Group)

tetramethylphosphonium dimethyl phosphate, tetraethylphosphonium dimethyl phosphate, tetra-n-propylphosphonium dimethyl phosphate, tetra-n-butylphosphonium dimethyl phosphate, tetra-n-pentylphosphonium dimethyl phosphate, tetra-n-hexylphosphonium dimethyl phosphate, ethyltrimethylphosphonium dimethyl phosphate, methyltriethylphosphonium dimethyl phosphate, methyltri-n-propylphosphonium dimethyl phosphate, methyltri-n-butylphosphonium dimethyl phosphate, methyltri-n-pentylphosphonium dimethyl phosphate, methyltri-n-hexylphosphonium dimethyl phosphate, methyltricyclopentylphosphonium dimethyl phosphate, methyltricyclohexylphosphonium dimethyl phosphate, diethyldimethylphosphonium dimethyl phosphate, di-n-propylethylmethylphosphonium dimethyl phosphate, di-n-butylethyl-n-propylphosphonium dimethyl phosphate;

### (Diethyl Phosphate Group)

tetramethylphosphonium diethyl phosphate, tetraethylphosphonium diethyl phosphate, tetra-n-propylphosphonium diethyl phosphate, tetra-n-butylphosphonium diethyl phosphate, tetra-n-pentylphosphonium diethyl phosphate, tetra-n-hexylphosphonium diethyl phosphate;

### (Di-n-propyl Phosphate Group)

tetramethylphosphonium di-n-propyl phosphate, tetraethylphosphonium di-n-propyl phosphate, tetra-n-propylphosphonium di-n-propyl phosphate, tetra-n-butylphosphonium di-n-propyl phosphate, tetra-n-pentylphosphonium di-n-propyl phosphate, tetra-n-hexylphosphonium di-n-propyl phosphate;

### (Di-n-butyl Phosphate Group)

tetramethylphosphonium di-n-butyl phosphate, tetraethylphosphonium di-n-butyl phosphate, tetra-n-propylphosphonium di-n-butyl phosphate, tetra-n-butylphosphonium di-n-butyl phosphate, tetra-n-pentylphosphonium di-n-butyl phosphate, tetra-n-hexylphosphonium di-n-butyl phosphate, methyltri-n-butylphosphonium di-n-butyl phosphate, ethyltri-n-butylphosphonium di-n-butyl phosphate, n-propyltri-n-butylphosphonium di-n-butyl phosphate, n-pentyltri-n-butylphosphonium di-n-butyl phosphate, n-hexyltri-n-butylphosphonium di-n-butyl phosphate, methyltriethylphosphonium di-n-butyl phosphate, methyltri-n-propylphosphonium di-n-butyl phosphate, methyltri-n-pentylphosphonium di-n-butyl phosphate, methyltri-n-hexylphosphonium di-n-butyl phosphate, methyltricyclopentylphosphonium di-n-butyl phosphate, methyltricyclohexylphosphonium di-n-butyl phosphate, n-butylethylmethyl-n-propylphosphonium di-n-butyl phosphate;

### (Di-n-octyl Phosphate Group)

tetramethylphosphonium di-n-octyl phosphate, tetraethylphosphonium di-n-octyl phosphate, tetra-n-propylphosphonium di-n-octyl phosphate, tetra-n-butylphosphonium di-n-octyl phosphate, tetra-n-pentylphosphonium di-n-octyl phosphate, tetra-n-hexylphosphonium di-n-octyl phosphate, ethyltrimethylphosphonium di-n-octyl phosphate, methyltriethylphosphonium di-n-octyl phosphate, methyltri-n-propylphosphonium di-n-octyl phosphate, methyltri-n-butylphosphonium di-n-octyl phosphate, methyltri-n-pentylphosphonium di-n-octyl phosphate, methyltri-n-hexylphosphonium di-n-octyl phosphate, methyltricyclopentylphosphonium di-n-octyl phosphate, methyltricyclohexylphosphonium di-n-octyl phosphate, diethyldimethylphosphonium di-n-octyl phosphate, di-n-propylethylmethyl phosphonium di-n-octyl phosphate, di-n-butylethyl-n-propylphosphonium di-n-octyl phosphate;

### (Ethylmethyl Phosphate Group)

methyltri-n-butylphosphonium ethylmethyl phosphate, tetra-n-butylphosphonium ethylmethyl phosphate, tetramethylphosphonium ethylmethyl phosphate, tetraethylphosphonium ethylmethyl phosphate, tetra-n-propylphosphonium ethylmethyl phosphate, tetra-n-pentylphosphonium ethylmethyl phosphate, tetra-n-hexylphosphonium ethylmethyl phosphate
   (Dicyclohexyl Phosphate Group) tetramethylphosphonium dicyclohexyl phosphate, tetraethylphosphonium dicyclohexyl phosphate, tetra-n-propylphosphonium dicyclohexyl phosphate, tetra-n-butylphosphonium dicyclohexyl phosphate, tetra-n-pentylphosphonium dicyclohexyl phosphate, tetra-n-hexylphosphonium dicyclohexyl phosphate.

Among these compounds, preferred are methyltri-n-butylphosphonium dimethyl phosphate, tetra-n-butylphosphonium di-n-butyl phosphate, tetra-n-butylphosphonium dimethyl phosphate, methyltri-n-butylphosphonium di-n-butyl phosphate, and tetra-n-butylphosphonium di-n-octyl phosphate; and particularly preferred are methyltri-n-butylphosphonium dimethyl phosphate, tetra-n-butylphosphonium di-n-butyl phosphate, and tetra-n-butylphosphonium di-n-octyl phosphate in that there is no tendency that the ultraviolet absorption region extends to the long wavelength side, thereby improving resistance to deep-ultraviolet light.

Further, the tetraalkylphosphonium dialkyl phosphate represented by the general formula (1) may be used alone or in combination of two or more.

The content of halogen ions in the tetraalkylphosphonium dialkyl phosphate represented by the general formula (1) is preferably 300 ppm or less, more preferably 100 ppm or less, further preferably 20 ppm or less, most preferably 10 ppm or less. The resistance to deep-ultraviolet light and heat resistance of the epoxy resin cured product are improved when the content of halogen ions in the tetraalkylphosphonium dialkyl phosphate represented by the general formula (1) is in the range as described above. Note that, these halogen ions are impurities contaminated when a compound containing halogen ions is used as a raw material for producing the tetraalkylphosphonium dialkyl phosphate represented by the general formula (1). Halogen ions react with an epoxy resin or the like to produce halogen chemical species having coloration properties, and such coloration by halogen ions is particularly significant at high temperatures. Therefore, it is not preferred that a halogen compound be contained in the epoxy resin composition because it will cause a reduction in the heat resistance of the epoxy resin cured product.

The method for producing the tetraalkylphosphonium dialkyl phosphate represented by the general formula (1) is not particularly limited. For example, there can be mentioned a production method comprising reacting a tetraalkylphosphonium halide with a metal salt of a dialkylphosphoric acid as described in Japanese Patent Laid-Open No. 2-40389 (hereinafter also referred to as production method 1); and a production method comprising reacting a tetraalkylphosphonium halide with a dialkylphosphoric acid as described in U.S. Pat. No. 3,050,543B (hereinafter also referred to as production method 2).

Since a compound containing halogen ions is used as a raw material for the production in production method 1 and production method 2, the resulting tetraalkylphosphonium dialkyl phosphate represented by the general formula (1) irreversibly contains halogen ions generally in an amount exceeding 300 ppm. The halogen ions cause the reduction of the resistance to deep-ultraviolet light and heat resistance of the epoxy resin cured product. Therefore, in production method 1 and production method 2, it is preferred to repeat washing with water of the produced tetraalkylphosphonium dialkyl phosphate represented by the general formula (1) in terms of improving the resistance to deep-ultraviolet light and light-transmitting properties of the epoxy resin cured product.

In addition, there can be mentioned a production method as shown below (hereinafter also referred to as production method 3) besides production method 1 and production method 2.

Production method 3 is a method comprising reacting a tertiary phosphine represented by the general formula (2) with a phosphoric ester represented by the general formula (3). Note that, R¹, R², and R³ in the general formula (2) have the same meaning as R¹, R², and R³ in the general formula (1), and R⁴, R⁵, and R⁶ in the general formula (3) have the same meaning as R⁴, R⁵, and R⁶ in the general formula (1).

In production method 3, the reaction of the tertiary phosphine represented by the general formula (2) with the phosphoric ester represented by the general formula (3) is performed by reacting from 1 to 2 mol, preferably from 1 to 1.05 mol of phosphoric ester relative to 1 mol of tertiary phosphine in a solvent such as toluene or without solvent, preferably without solvent in an inert gas atmosphere at 80 to 300° C., preferably at 100 to 250° C. for 3 to 20 hours, preferably for 5 to 15 hours.

In production method 3, since the raw materials are compounds containing no halogen ions, the tetraalkylphosphonium dialkyl phosphate represented by the general formula (1) containing only a small amount of halogen ions can be obtained without washing with water. Among the tetraalkylphosphonium dialkyl phosphate represented by the general formula (1), a tetraalkylphosphonium dialkyl phosphate represented by the general formula (1) in which all of R¹, R², R³, R⁴, R⁵, and R⁶ have 4 or less carbon atoms is water soluble. Therefore, it is difficult to remove halogen ions by washing it with water.

Therefore, production method 3 is preferred in that all of R¹, R², R³, R⁴, R⁵, and R⁶ in the general formula (1) have 4 or less carbon atoms, and it is possible to obtain a tetraalkylphosphonium dialkyl phosphate represented by the general formula (1) containing only a small amount of halogen ions.

The deep-ultraviolet-transmitting epoxy resin composition of the present invention comprises an epoxy resin, a carboxylic anhydride curing agent, and a curing accelerator; the curing accelerator is a curing accelerator for deep-ultraviolet-transmitting epoxy resins of the present invention; and the content of the curing accelerator is from 0.01 to 10 parts by mass based on 100 parts by mass of the epoxy resin. Specifically, the deep-ultraviolet-transmitting epoxy resin composition of the present invention comprises an epoxy resin, a carboxylic anhydride curing agent, and a curing accelerator; the curing accelerator is a tetraalkylphosphonium dialkyl phosphate represented by the general formula (1); and the content of the tetraalkylphosphonium dialkyl phosphate represented by the general formula (1) is from 0.01 to 10 parts by mass based on 100 parts by mass of the epoxy resin.

The epoxy resin for the deep-ultraviolet-transmitting epoxy resin composition of the present invention is not particularly limited as long as it is an epoxy resin having no photosensitive site in the molecule. Examples of the epoxy resin include a transparent epoxy resin such as a hydrogenated bisphenol A-type epoxy resin, a hydrogenated bisphenol AD-type epoxy resin, a hydrogenated bisphenol F-type epoxy resin, and a cycloaliphatic epoxy resin. The epoxy resin may also be used alone or in combination of two or more. The epoxy resin may also be liquid or solid at ordinary temperature. Note that, in the present invention, the photosensitive site refers to an atom, a substituent, or a molecular structure which absorbs deep-ultraviolet light such as an unsaturated bond, an aromatic ring, halogen except fluorine, sulfur, selenium, or tellurium.

The carboxylic anhydride curing agent for the deep-ultraviolet-transmitting epoxy resin composition of the present invention is not particularly limited as long as it is a carboxylic anhydride having no photosensitive site other than an oxygen-carbon double bond of a carbonyl group forming a carboxylic anhydride skeleton. Examples of the carboxylic anhydride curing agent include an acid anhydride such as hexahydrophthalic anhydride, 4-methylhexahydrophthalic anhydride, succinic anhydride, glutaric anhydride, and adipic anhydride. Further, the carboxylic anhydride curing agent may be used alone or in combination of two or more.

The curing accelerator for the deep-ultraviolet-transmitting epoxy resin composition of the present invention is a tetraalkylphosphonium dialkyl phosphate represented by the general formula (1) and is the same as the tetraalkylphosphonium dialkyl phosphate represented by the general formula (1) for the curing accelerator for deep-ultraviolet-transmitting epoxy resins of the present invention.

The content of the curing accelerator in the deep-ultraviolet-transmitting epoxy resin composition of the present invention is from 0.01 to 10 parts by mass, preferably from 0.01 to 2 parts by mass based on 100 parts by mass of the epoxy resin. When the content of the curing accelerator in the deep-ultraviolet-transmitting epoxy resin composition of the present invention is less than 0.01 parts by mass based on 100 parts by mass of the epoxy resin, it will be difficult to obtain the effect of the curing accelerator, and when it exceeds 10 parts by mass, discoloration caused by the curing accelerator will be increased to reduce the resistance to deep-ultraviolet light of the epoxy resin cured product.

The content of the carboxylic anhydride in the deep-ultraviolet-transmitting epoxy resin composition of the present invention is preferably 50 to 200 parts by mass, particularly preferably 50 to 100 parts by mass based on 100 parts by mass of the epoxy resin.

The deep-ultraviolet-transmitting epoxy resin composition of the present invention can optionally contain other additives. Examples of the other additives include known additives such as a discoloration inhibitor, an antiaging agent, a release agent, an inorganic filler, a modifier, a silane coupling agent, a pigment, a dye, and a reactive or non-reactive diluent.

The deep-ultraviolet-transmitting epoxy resin composition of the present invention is obtained by uniformly mixing an epoxy resin, a carboxylic anhydride curing agent, a curing accelerator for deep-ultraviolet-transmitting epoxy resin of the present invention, and optionally other additives at a room temperature of about 25° C. or under heating according to conventional methods.

The optical semiconductor sealed with the deep-ultraviolet-transmitting epoxy resin composition of the present invention is not particularly limited, and examples thereof include a photodiode to detect light, a light emitting diode (LED) which emits light when electric current is supplied, and the like.

The deep-ultraviolet-transmitting epoxy resin cured product of the present invention is obtained by curing the deep-ultraviolet-transmitting epoxy resin composition of the present invention.

Conventional deep-ultraviolet-transmitting epoxy resin cured products had low resistance to deep-ultraviolet light or heat resistance in spite of the fact that they have used an epoxy resin having high deep-ultraviolet light transmitting properties such as a hydrogenated bisphenol A glycidyl ether and a curing agent having high deep-ultraviolet light transmitting properties such as hexahydrophthalic acid, because the curing accelerator used therein had a low resistance to deep-ultraviolet light or heat resistance.

On the other hand, the curing accelerator for deep-ultraviolet-transmitting epoxy resin of the present invention is excellent in light-transmitting properties in a wide wavelength range and is also excellent in light-transmitting properties of a deep-ultraviolet light having a wavelength of 300 mm or less. Therefore, the deep-ultraviolet-transmitting epoxy resin cured product of the present invention, in which the curing accelerator for deep-ultraviolet-transmitting epoxy resins of the present invention is used as a curing accelerator, is excellent in light-transmitting properties in a wide wavelength range and has high resistance to deep-ultraviolet light. Specifically, the deep-ultraviolet-transmitting epoxy resin cured product of the present invention exhibits only a small color change due to discoloration even when it is exposed to deep-ultraviolet light for a long period of time, which indicates excellent durability of this product.

Further, the deep-ultraviolet-transmitting epoxy resin cured product of the present invention has high heat resistance because the curing accelerator for deep-ultraviolet-transmitting epoxy resin of the present invention has high heat resistance.

More specifically, the deep-ultraviolet-transmitting epoxy resin cured product of the present invention has higher resistance to deep-ultraviolet light and higher heat resistance compared with the deep-ultraviolet-transmitting epoxy resin cured products which have been cured by using tetraalkylphosphonium O,O-dialkylphosphorodithioate, tetraphenylphosphonium bromide, or an imidazole-based curing accelerator, which have been conventionally used.

Further, the deep-ultraviolet-transmitting epoxy resin composition using the tetraalkylphosphonium dialkyl phosphate represented by the general formula (1) and the deep-ultraviolet-transmitting epoxy resin composition using tetraalkylphosphonium O,O-dialkylphosphorodithioate produce cured products having higher resistance to deep-ultraviolet light but exhibit slower cure rates compared with the deep-ultraviolet-transmitting epoxy resin composition using tetraphenylphosphonium bromide or the deep-ultraviolet-transmitting epoxy resin composition using an imidazole-based curing accelerator.

Therefore, in order to increase the cure rate in the case of using the tetraalkylphosphonium dialkyl phosphate represented by the general formula (1) or in the case of using tetraalkylphosphonium O,O-dialkylphosphorodithioate to the same level as the cure rate in the case of using tetraphenylphosphonium bromide or an imidazole-based curing accelerator, the content of the curing accelerator must be increased.

However, when the content of tetraalkylphosphonium O,O-dialkylphosphorodithioate is increased, the resistance to deep-ultraviolet light and heat resistance of the deep-ultraviolet-transmitting epoxy resin cured product will be reduced. Therefore, when tetraalkylphosphonium O,O-dialkylphosphorodithioate is used as a curing accelerator, it is impossible to produce a cured product having high resistance to deep-ultraviolet light and high heat resistance and at the same time to increase the cure rate to the same level as in the case where tetraphenyl phosphonium bromide or an imidazole-based curing accelerator is used.

On the other hand, the deep-ultraviolet-transmitting epoxy resin cured product using the tetraalkylphosphonium dialkyl phosphate represented by the general formula (1) shows smaller decrease in the resistance to deep-ultraviolet light and heat resistance at the time of increasing the content of the curing accelerator compared with the deep-ultraviolet-transmitting epoxy resin cured product using tetraalkylphosphonium O,O-dialkylphosphorodithioate. And the resistance to deep-ultraviolet light and heat resistance of a cured product are kept at a high level even when the content of the tetraalkylphosphonium dialkyl phosphate represented by the general formula (1) is increased to the extent that the cure rate is increased to the degree equivalent to that in the case of using tetraphenyl phosphonium bromide or an imidazole-based curing accelerator. Therefore, by using the tetraalkylphosphonium dialkyl phosphate represented by the general formula (1), it is possible to improve the resistance to deep-ultraviolet light and heat resistance of a cured product and at the same time bring the cure rate to the level equivalent to that in the case where the cured product is obtained by using tetraphenyl phosphonium bromide or an imidazole-based curing accelerator.

Further, as described above, the curing accelerator for deep-ultraviolet-transmitting epoxy resins of the present invention and the deep-ultraviolet-transmitting epoxy resin composition of the present invention have high heat resistance, high light-transmitting properties in a wide wavelength range, and high resistance to deep-ultraviolet light. Therefore, the curing accelerator for deep-ultraviolet-transmitting epoxy resins of the present invention and the deep-ultraviolet-transmitting epoxy resin composition of the present invention can be used for other fields requiring light-transmitting properties, heat resistance, and resistance to deep-ultraviolet light besides an optical semiconductor sealing application, for example, for resin sheets such as liquid crystal cell substrates.

Hereinafter, the present invention will be described in more detail with reference to Examples, but these are only illustration and do not limit the present invention.

### Examples

### Example 1

Under a nitrogen atmosphere, 1.0 mol of tri-n-butyl phosphine (trade name: HISHICOLIN P-4, manufactured by the Nippon Chemical Industrial Co., Ltd.) was mixed with 1.0 mol of trimethyl phosphate (manufactured by Daihachi Chemical Industry Co., Ltd.), and they were allowed to react with each other at 120° C. for 8 hours. The reaction mixture was then cooled to room temperature and sufficiently washed with n-hexane, followed by concentration to give a reaction product. The structure of the reaction product was determined by NMR, and it was confirmed that the reaction product was methyltri-n-butylphosphonium dimethyl phosphate. Further, the purity was found to be 96.40%. Furthermore, the halogen ion content determined by silver nitrate titration was 5 ppm in terms of chlorine.

### (Test for Light-Transmitting-Properties)

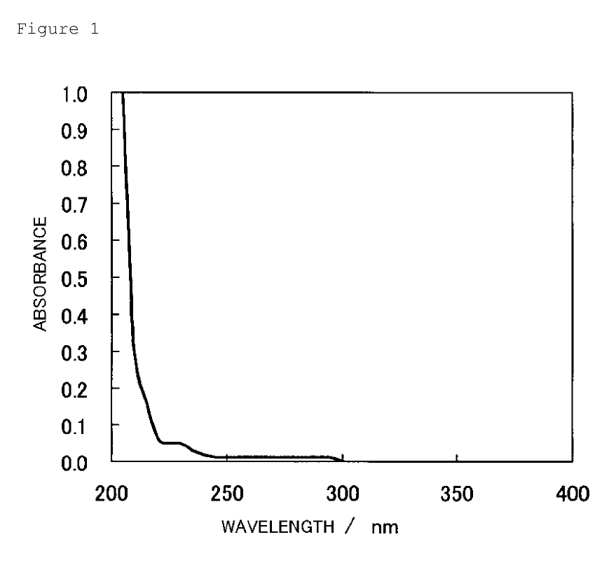

The methyltri-n-butylphosphonium dimethyl phosphate obtained as described above was dissolved in acetonitrile to prepare a 0.1M acetonitrile solution, which was then filled into a 1 cm quartz cell to measure the UV absorption-spectrum. The measurement was performed in a wavelength range of 200 nm to 400 mm using a spectrophotometer (U-3400, manufactured by Hitachi, Ltd.) as a measuring apparatus. The result of the measurement is shown in FIG. 1.

### Example 2

Under a nitrogen atmosphere, 1.0 mol of tri-n-butyl phosphine (trade name: HISHICOLIN P-4, manufactured by the Nippon Chemical Industrial Co., Ltd.) was mixed with 1.0 mol of tri-n-butyl phosphate (manufactured by Daihachi Chemical Industry Co., Ltd.), and they were allowed to react with each other at 230° C. for 13 hours. The reaction mixture was then cooled to room temperature and sufficiently washed with n-hexane, followed by concentration to give a reaction product. The structure of the reaction product was determined by NMR, and it was confirmed that the reaction product was tetra-n-butylphosphonium di-n-butyl phosphate. Further, the purity was found to be 96.96%. Furthermore, the halogen ion content determined by silver nitrate titration was 4 ppm in terms of chlorine.

### (Test for Light-Transmitting-Properties)

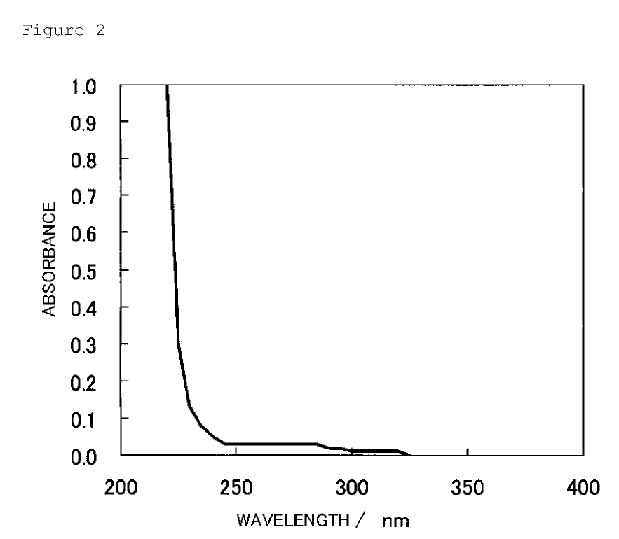

The test was performed in the same manner as in Example 1 except that methyltri-n-butylphosphonium dimethyl phosphate was replaced with tetra-n-butylphosphonium di-n-butyl phosphate obtained as described above. The result of the measurement is shown in FIG. 2.

### Example 3

To di-n-octyl phosphoric acid (161 g) was dropped a 25% aqueous sodium hydroxide solution (84 g), and then thereto was added an 80% aqueous tetra-n-butylphosphonium chloride solution (183 g). The resulting mixture was allowed to react with each other at room temperature for 6 hours. To the reaction mixture, were charged 400 g of toluene and 200 g of pure water, followed by agitation followed by still standing for separation. Then, the lower water layer was removed from the reaction mixture, and the remaining mixture was then washed with water. The upper toluene layer was further washed 3 times with water in the same manner and then concentrated to give a reaction product. The structure of the reaction product was determined by NMR, and it was confirmed that the reaction product was tetra-n-butylphosphonium di-n-octyl phosphate. Further, the purity was found to be 97.36%. Furthermore, the halogen ion content determined by silver nitrate titration was 7 ppm in terms of chlorine.

### (Test for Light-Transmitting-Properties)

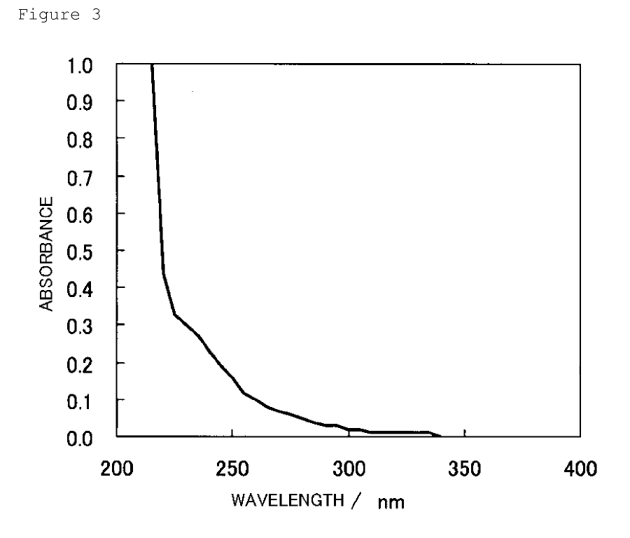

The test was performed in the same manner as in Example 1 except that methyltri-n-butylphosphonium dimethyl phosphate was replaced with tetra-n-butylphosphonium di-n-octyl phosphate obtained as described above. The result of the measurement is shown in FIG. 3.

### Comparative Example 1

A commercially' available tetra-n-butylphosphonium O,O-diethylphosphorodithioate was prepared.

### (Test for Light-Transmitting-Properties)

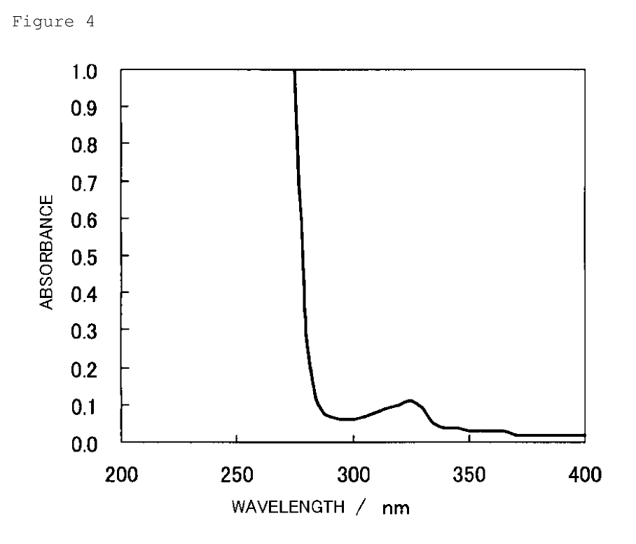

The test was performed in the same manner as in Example 1 except that methyltri-n-butylphosphonium dimethyl phosphate was replaced with the commercially available tetra-n-butylphosphonium O,O-diethylphosphorodithioate. The result of the measurement is shown in FIG. 4.

### Comparative Example 2

A commercially available tetraphenylphosphonium bromide was prepared.

### (Test for Light-Transmitting-Properties)

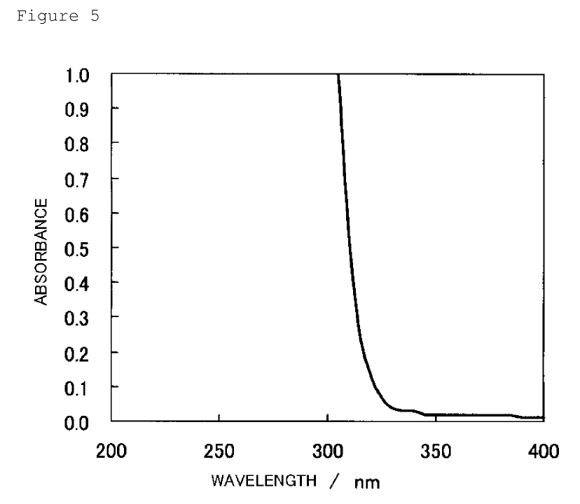

The test was performed in the same manner as in Example 1 except that methyltri-n-butylphosphonium dimethyl phosphate was replaced with the commercially available tetraphenylphosphonium bromide. The result of the measurement is shown in FIG. 5.

### Comparative Example 3

A commercially available 2-ethyl-4-methylimidazole was prepared.

### (Test for Light-Transmitting-Properties)

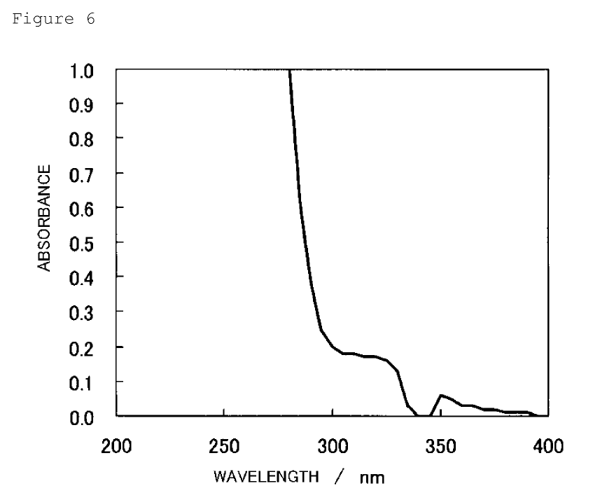

The test was performed in the same manner as in Example 1 except that methyltri-n-butylphosphonium dimethyl phosphate was replaced with the commercially available 2-ethyl-4-methylimidazole. The result of the measurement is shown in FIG. 6.

As apparent from the results of the tests for light-transmitting-properties, it is found that the curing accelerators for deep-ultraviolet-transmitting epoxy resins of the present invention have high transmittance properties to the light having a wavelength 300 nm or less.

### Examples 4 to 6, Comparative Examples 4 to 6

### (Production of Deep-Ultraviolet-Transmitting Epoxy Resin Composition)

A deep-ultraviolet-transmitting epoxy resin composition was produced by mixing 100 parts by mass of a hydrogenated bisphenol A glycidyl ether (trade name “Epicoat YX 8000”, manufactured by Japan Epoxy Resins Co., Ltd.) as an epoxy resin, 85 parts by mass of 4-methylcyclohexane dicarboxylic anhydride (manufactured by Tokyo Chemical Industry Co., Ltd.) as a curing agent, and 2 parts by mass of a curing accelerator shown in Table 1 as a curing accelerator, at room temperature until the resulting mixture was uniform.

### (Measurement of Gel Time)

The deep-ultraviolet-transmitting epoxy resin composition obtained as described above was put into a gel time measuring instrument (Gel-time Tester, manufactured by Toyo Seiki Seisaku-sho, Ltd.) and heated to 150° C. to measure the time required until the measured load reaches 80 G. This measurement was repeated 10 times, and the average of the time required until the measured load reaches 80 G was determined as a gel time. The resulting gel time was divided by a value of the molar concentration of an accelerator to determine a relative gel time (curing performance per 1 mol of an accelerator/kg).

### (Production of Deep-Ultraviolet-Transmitting Epoxy Resin Cured Product)

A part of the deep-ultraviolet-transmitting epoxy resin composition obtained as described above was put in an aluminum vessel 6 cm in diameter so that the thickness of the resin composition was 5 mm, and it was allowed to cure over 5 hours at 100° C. After curing, a piece of resin was taken out from the aluminum vessel, thus obtaining a resin test piece of the deep-ultraviolet-transmitting epoxy resin cured product.

### (Test for Resistance to Deep-Ultraviolet Light)

The resin test piece obtained as described above was irradiated with ultraviolet light at 25° C. using a low-pressure mercury lamp (wavelength of 254 nm, output 2,020 μW/cm², manufactured by AS ONE Corporation) located at a distance to the resin test piece of 50 mm. The resin test piece was measured for the light transmittance at 400 nm using a spectrophotometer (U-3400, manufactured by Hitachi, Ltd.) after irradiation for a predetermined time. Then, an A value represented by the following formula (4) was calculated to determine the change of the A value with time:

A value (%)=100×T0₄₀₀/Tx₄₀₀ (4)

wherein, T0₄₀₀ represents the light transmittance at 400 nm of a resin test piece before the test for resistance to deep-ultraviolet light, and Tx₄₀₀ represents the light transmittance at 400 nm of a resin test piece after x-hour ultraviolet irradiation.

Further, after irradiation for a predetermined time, the yellowness (Yellowness Index: ASTM D1925) of a resin test piece was determined by the following formula (5):

Yellowness (YI)=100×(1.28×X−1.06×Z)/Y

wherein X, Y, and Z represent the tristimulus values of a resin test piece, and X, Y, and Z are the stimulus values for red, green, and blue, respectively. From the resulting yellowness, the difference between the yellowness YIₙ of a resin test piece after n-hour ultraviolet irradiation and the yellowness YI₀ of a resin test piece before the test for resistance to deep-ultraviolet light was determined by the following formula (6):

Yellowing factor (ΔYIₙ)=YIₙ−YI₀ (6),

as a yellowing factor (ΔYIₙ) after n-hour ultraviolet irradiation.

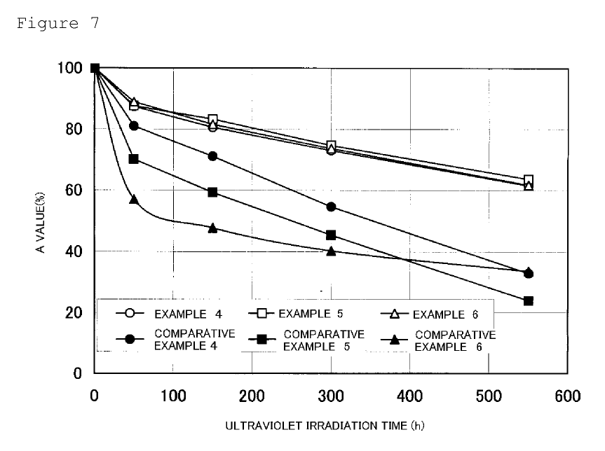

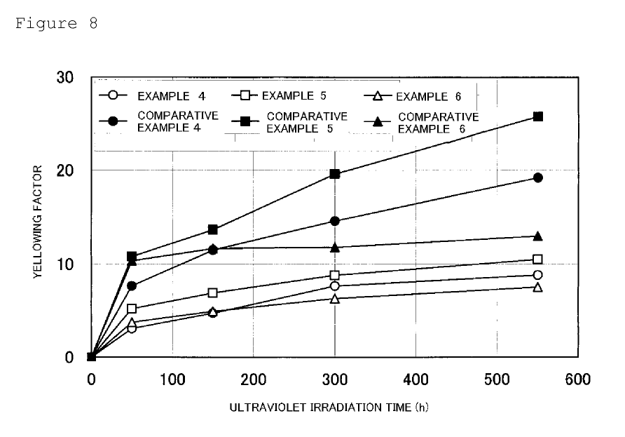

The results of the change of A values with time are shown in Table 1 and FIG. 7, and the results of the change of yellowing factors with time are shown in Table 1 and FIG. 8.

### (Heat Resistance Test)

A resin test piece prepared besides the test piece for the test for resistance to deep-ultraviolet light was heated in a constant temperature bath in an air atmosphere of 200° C. After the elapse of a predetermined time, the yellowness (YI) of the resin test piece was determined by the above formula (5). From the resulting yellowness, the difference of the yellowness YIₘ of the resin test piece after m-hour heating and the yellowness YI₀ of the resin test piece before the heat resistance test was determined by the following formula (7):

Yellowing factor (ΔYIₘ)=YIₘ−YI₀ (7),

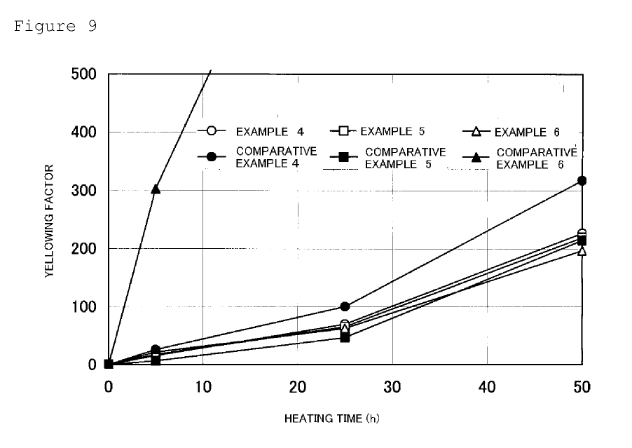

as a yellowing factor (ΔYIₘ) after m-hour heating. The results of the change of yellowing factors with time are shown in Table 1 and FIG. 9.

TABLE 1

| | Example | | | Comparative Example | | |
|---|---|---|---|---|---|---|
| | 4 | 5 | 6 | 4 | 5 | 6 |
| Type of curing accelerator | A | B | C | D | E | F |
| Loading (parts by mass) | | | | | | |
| Epoxy resin | 100 | 100 | 100 | 100 | 100 | 100 |
| Curing agent | 85 | 85 | 85 | 85 | 85 | 85 |
| Curing accelerator | 2 | 2 | 2 | 2 | 2 | 2 |
| Measurement of gel time | | | | | | |
| Gel time (sec) | 506 | 570 | 702 | 516 | 408 | 226 |
| Relative gel time | 16900 | 25900 | 39400 | 21700 | 160000 | 2400 |
| (sec · kg/mol) | | | | | | |
| Test for resistance to | | | | | | |
| deep-ultraviolet light | | | | | | |
| A value (%) | | | | | | |
| Before irradiation | 100 | 100 | 100 | 100 | 100 | 100 |
| (0 hour) | | | | | | |
| After 50-hour irradiation | 87.4 | 87.6 | 88.9 | 81.0 | 70.1 | 57.0 |
| After 150-hour irradiation | 80.6 | 83.3 | 81.6 | 71.1 | 59.3 | 47.7 |
| After 300-hour irradiation | 73.0 | 74.7 | 73.7 | 54.6 | 45.4 | 40.3 |
| After 550-hour irradiation | 61.5 | 63.6 | 61.7 | 32.9 | 24.0 | 33.6 |
| Yellowing factor (ΔYIₙ) | | | | | | |
| Before irradiation | 0.00 | 0.00 | 0.00 | 0.00 | 0.00 | 0.00 |
| (0 hour) | | | | | | |
| After 50-hour irradiation | 3.09 | 5.26 | 3.77 | 7.68 | 10.82 | 10.38 |
| After 150-hour irradiation | 4.77 | 6.94 | 4.98 | 11.52 | 13.66 | 11.68 |
| After 300-hour irradiation | 7.69 | 8.83 | 6.34 | 14.59 | 19.59 | 11.81 |
| After 550-hour irradiation | 8.84 | 10.52 | 7.55 | 19.2 | 25.78 | 12.98 |
| Heat resistance test | | | | | | |
| Yellowing factor (ΔYIₘ) | | | | | | |
| Before heating (0 hour) | 0.00 | 0.00 | 0.00 | 0.00 | 0.00 | 0.00 |
| After 5-hour heating | 15.87 | 17.53 | 21.64 | 26.17 | 6.43 | 302.9 |
| After 25-hour heating | 70.29 | 65.74 | 62.97 | 100.6 | 47.16 | 1000< |
| After 50-hour heating | 226.8 | 219.2 | 196.8 | 317.6 | 214.4 | 1000< |

Note that, the type of the curing accelerators in Table 1 is as follows.

Curing accelerator A: methyltri-n-butylphosphonium dimethyl phosphate obtained in Example 1

Curing accelerator B: tetra-n-butylphosphonium di-n-butyl phosphate obtained in Example 2

Curing accelerator C: tetra-n-butylphosphonium di-n-octyl phosphate obtained in Example 3

Curing accelerator D: a commercially available tetra-n-butylphosphonium O,O-diethylphosphorodithioate prepared in Comparative Example 1

Curing accelerator E: a commercially available tetraphenyl phosphonium bromide prepared in Comparative Example 2

Curing accelerator F: a commercially available 2-ethyl-4-methylimidazole prepared in Comparative Example 3

The results of the measurement of gel time showed that the curing accelerators A, B, and C which are curing accelerators for deep-ultraviolet-transmitting epoxy resins of the present invention had a gel time equivalent to the curing accelerator D which is tetraalkylphosphonium O,O-dialkylphosphorodithioate. Further, the gel time of the curing accelerator A was found to be equal to that of tetraphenyl phosphonium bromide, which means that the curing accelerator A has excellent curing acceleration ability.

According to the results of the measurement of the change of A values in the test for resistance to deep-ultraviolet light with time, the epoxy resin cured products obtained in Examples 4 to 6 showed a smaller decrease in the light transmittance at 400 nm when irradiated with deep-ultraviolet light for a long time compared with the epoxy resin cured products obtained in Comparative Examples 4 to 6. These results indicate that the epoxy resin cured products obtained in Examples 4 to 6 can maintain high light-transmitting properties even when irradiated with deep-ultraviolet light for a long time compared with the epoxy resin cured products obtained in Comparative Examples 4 to 6. Note that, the A value represented by the formula (4) is the percentage of the light transmittance at 400 nm of a cured product after ultraviolet irradiation relative to the light transmittance at 400 nm of a cured product before ultraviolet irradiation, and is a value which shows the degree of decrease in light-transmitting properties. A larger A value indicates a smaller decrease in light-transmitting properties.

Further, according to the results of the measurement of the change of yellowing factors with time in the test for resistance to deep-ultraviolet light, the epoxy resin cured products obtained in Examples 4 to 6 each had a yellowing factor when irradiated with deep-ultraviolet light for 550 hours of a low value of about 10 while the epoxy resin cured products obtained in Comparative Examples 4 to 6 each had a yellowing factor when irradiated with deep-ultraviolet light for 550 hours of a value exceeding 12. Particularly, the epoxy resin cured products obtained in Comparative Examples 4 and 5 each had a yellowing factor when irradiated with deep-ultraviolet light for 550 hours of a value exceeding 19. These results indicate that the epoxy resin cured products obtained in Examples 4 to 6 is hard to be discolored even when irradiated with deep-ultraviolet light for a long time compared with the epoxy resin cured products obtained in Comparative Examples 4 to 6. Note that, the yellowing factor represented by the formula (6) and the yellowing factor represented by the formula (7) each represent a value as an index indicating the degree of discoloration of an epoxy resin cured product, and a larger value of the yellowing factor indicates a larger degree of discoloration.

Furthermore, regarding the change of yellowing factors with time in the test for resistance to deep-ultraviolet light, Comparative Example 6 showed a smaller change of the value of yellowing factors after deep-ultraviolet light irradiation for 550 hours compared with those shown in Comparative Examples 4 and 5. However, regarding the change of the yellowing factor with time in the heat resistance test, Comparative Example 6 had a value of the yellowing factor after 50-hour heating exceeding 1,000, which was a very high value compared with those of the epoxy resin cured products obtained in Examples 4 to 6.

Since the difference between the epoxy resins obtained in Examples 4 to 6 and the epoxy resins obtained in Comparative Examples 4 to 6 is only the curing accelerator used therein, it is apparent that the difference in the performance of these epoxy resin cured products depends on the difference in the curing accelerator used. Therefore, it is possible to produce a deep-ultraviolet-transmitting epoxy resin cured product having better resistance to deep-ultraviolet light and better heat resistance than those of conventional deep-ultraviolet-transmitting epoxy resin cured products by using a curing accelerator for deep-ultraviolet-transmitting epoxy resins of the present invention.

### Example 7 and Comparative Example 7

### (Production of Deep-Ultraviolet-Transmitting Epoxy Resin Composition)

Deep-ultraviolet-transmitting epoxy resin compositions were produced in the same manner as in Example 4 except that 2 parts by mass of the curing accelerators shown in Table 1 were replaced with 6 parts by mass of the curing accelerators shown in Table 2.

### (Measurement of Gel Time)

The measurement was performed in the same manner as in Example 4 to obtain gel time except that the deep-ultraviolet-transmitting epoxy resin compositions obtained as described above were used. The results are shown in Table 2.

### (Production of Deep-Ultraviolet-Transmitting Epoxy Resin Cured Product)

Resin test pieces of deep-ultraviolet-transmitting epoxy resin cured products were obtained in the same manner as in Example 4 except that the deep-ultraviolet-transmitting epoxy resin compositions obtained as described above were used.

### (Measurement of the Degree of Coloration by Curing Accelerator)

The yellowness before the test for resistance to deep-ultraviolet light of the resin test pieces obtained as described above was determined by the formula (5). The resulting yellowness was defined as a yellowness before the test for resistance to deep-ultraviolet light in the case where the loading of the curing accelerator was 6 parts by mass (YI₀ (6 parts by mass)). Then, a ratio (YI₀ (6 parts by mass)/YI₀ (2 parts by mass)) was calculated, which is the ratio of YI₀ (6 parts by mass) to the yellowness before the test for resistance to deep-ultraviolet light in the case where the loading of the curing accelerator was 2 parts by mass (YI₀ (2 parts by mass)). The results are shown in Table 2.

### (Test for Resistance to Deep-Ultraviolet Light)

The resin test pieces were irradiated with ultraviolet light for 50 hours in the same manner as in Example 4 except that the resin test pieces obtained as described above were used. The yellowness after 50-hour irradiation of the resin test pieces was obtained from the formula (5), and the yellowing factor (ΔYI₅₀) after 50-hour irradiation was determined from the obtained yellowness. The results are shown in Table 2.

TABLE 2

| | | Comparative | Comparative | Comparative |
|---|---|---|---|---|
| | Example 7 | Example 5 | Example 6 | Example 7 |
| Type of curing | A | E | F | D |
| accelerator | | | | |
| Loading (parts | | | | |
| by mass) | | | | |
| Epoxy resin | 100 | 100 | 100 | 100 |
| Curing agent | 85 | 85 | 85 | 85 |
| Curing | 6 | 2 | 2 | 6 |
| accelerator | | | | |
| Measurement of | | | | |
| gel time | | | | |
| Gel time (sec) | 239 | 408 | 226 | 243 |
| YI₀ (6 parts by | 1.16 | | | 1.16 |
| mass)/YI₀ (2 | | | | |
| parts by mass) | | | | |
| Test for resistance | | | | |
| to deep-ultraviolet | | | | |
| light | | | | |
| Yellowing factor | 8.2 | 10.82 | 10.38 | 25.86 |
| (ΔYI₅₀) | | | | |

By increasing the loadings to 6 parts by mass, the curing accelerator A and the curing accelerator D can give a gel time comparable to that in the case where the loading of the curing accelerator F is 2 parts by mass (Comparative Example 6).

The results of the ratio (YI₀ (6 parts by mass)/YI₀ (2 parts by mass)) showed that the increase in the loading of the curing accelerator A resulted in a small increase in the yellowness before the test for resistance to deep-ultraviolet light while the increase in the loading of the curing accelerator D resulted in a large increase in the yellowness before the test for resistance to deep-ultraviolet light. In addition, the yellowing factor after 50-hour ultraviolet irradiation was a small value of 8.20 in Example 7 while that in Comparative Example 7 was a large value of 25.86.

These results indicate that the curing accelerator for deep-ultraviolet-transmitting epoxy resins of the present invention can provide both high resistance to deep-ultraviolet light of an epoxy resin cured product and higher cure rate than that provided by tetraphenylphosphonium bromide, and that it can provide both high resistance to deep-ultraviolet light of an epoxy resin cured product and a cure rate equivalent to that provided by an imidazole-based curing accelerator. Therefore, it is possible to obtain gel time suitable for each application without reducing quality by changing the loading of the curing accelerator for deep-ultraviolet-transmitting epoxy resins of the present invention.

### Comparative Example 8

To dimethyl phosphoric acid (62.5 g) was dropped a 25% aqueous sodium hydroxide solution (84 g) and was further added an 80% aqueous methyltri-n-butyl phosphonium chloride solution (158 g). The resulting mixture was allowed to react with each other at room temperature for 6 hours. After completing the reaction, reaction mixture was concentrated to remove moisture. To the concentrate was added 200 g of methanol. The resulting mixture was stirred and left standing to separate solid and liquid to obtain a methanol layer. Subsequently, the methanol layer was concentrated to obtain a reaction product. The structure of the reaction product was determined by NMR, and it was confirmed that the reaction product was methyltri-n-butylphosphonium dimethyl phosphate. Further, the purity was found to be 95.02%. Furthermore, the halogen ion content determined by silver nitrate titration was 1,000 ppm in terms of chlorine.

### INDUSTRIAL APPLICABILITY

The present invention can provide a deep-ultraviolet-transmitting epoxy resin cured product having high heat resistance and high resistance to deep-ultraviolet light, and can provide a curing accelerator for deep-ultraviolet-transmitting epoxy resins and a deep-ultraviolet-transmitting epoxy resin composition which are used for producing the deep-ultraviolet-transmitting epoxy resin cured product.

1-3. (canceled)

4. A method for producing a curing accelerator for deep-ultraviolet-transmitting epoxy resins, characterized by comprising reacting a tertiary phosphine represented by the following general formula (2): 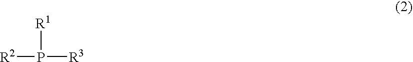
wherein R¹, R², and R³ each represent an alkyl group or an alkyl group having a hydroxyl group, which has 1 to 8 carbon atoms and is linear, branched, or alicyclic; and R¹, R², and R³ may be the same or different,
with a phosphoric ester represented by the following general formula (3): 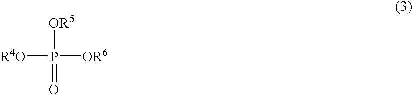
wherein R⁴, R⁵, and R⁶ each represent an alkyl group or an alkyl group having a hydroxyl group, which has 1 to 8 carbon atoms and is linear, branched, or alicyclic; and R⁴, R⁵, and R⁶ may be the same or different.

5-6. (canceled)
